(19) United States
(12) Patent Application Publication
(10) Pub. No.: US 2009/0070370 A1
(43) Pub. Date: Mar. 12, 2009

(54) TRACKBACKS FOR MEDIA ASSETS

(75) Inventors: Ryan B. Cunningham, San Francisco, CA (US); Chris Kalaboukis, Los Gatos, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/854,159

(22) Filed: Sep. 12, 2007

(51) Int. Cl. G06F 17/30

(52) U.S. Cl. 707/104.1; 707/E17.019

(57) ABSTRACT

Methods for creating a compilation of media assets and tracking uses of media assets are provided. In one example, the method includes generating a playlist referencing a first media asset and a second media asset, wherein the first media asset has a reference associated therewith (e.g., a tag or item in a database) identifying a source of the first media asset, and causing display of the first media asset and the second media asset per the playlist. The reference may also identify subsequent uses of the media asset, which may provide for tracking uses of the media asset, bidirectional linking of users of the media assets, e.g., linking of users, blog pages, websites, etc., using common media assets (even if within compilation or remixed media assets), and so on.

### RELATED APPLICATIONS

The present application is related to U.S. patent application Ser. Nos. 11/784,843, 11/784,918, 11/786,016, and 11/786,020, all of which were filed on Apr. 9, 2007, and all of which are hereby incorporated by reference herein in their entirety.

### BACKGROUND

1. Field

The present invention relates generally to systems and methods for the editing and generation of media assets such as video and/or audio assets via a network, such as the Internet or an intranet, and in particular, to systems and methods for creating compilations of media assets and tracking media assets used in aggregate or compilation media assets.

2. Description of Related Art

Currently there exist many different types of media assets in the form of digital files that are transmitted via the Internet. Digital files may contain data representing one or more types of content, including but not limited to, audio, images, and videos. For example, media assets include file formats such as MPEG-1 Audio Layer 3 (“MP3”) for audio, Joint Photographic Experts Group (“JPEG”) for images, Motion Picture Experts Group (“MPEG-2” and “MPEG-4”) for video, Adobe Flash for animations, and executable files.

Such media assets may be viewed via a variety of media players, e.g., via Windows Media Player, RealPlayer, and the like. Further, media assets may be created and edited using applications executing locally on a dedicated computer via Apple's iMovie and FinalCut Pro and Microsoft's MovieMaker. Additionally, web-based media players and edit applications are available. One exemplary web-based editor application includes JumpCut (jumpcut.com), whereby users may search, grab, and edit content, e.g., media assets, into aggregate media assets. For example, a user may search and use a particular video/audio clip or image with a user-generated movie or within a personal web page or blog.

### SUMMARY

According to one aspect of the present invention, methods for creating a compilation of media assets are provided. In one example, a method includes generating a playlist (which may include one or more edit instructions) referencing a first media asset and a second media asset, wherein the first media asset has a reference associated therewith identifying a source of the first media asset, and causing display of the first media asset and the second media asset per the playlist. The second media asset may further have a second reference associated therewith identifying a source thereof.

In one example, the reference associated with the first media asset (or an additional reference) may identify subsequent uses of the media asset, which may provide for tracking uses of the media asset, bidirectional linking of users of the media assets, e.g., linking of users, blog pages, web sites, etc., using the first media asset (even if within compilation or remixed media assets), and so on. The reference may comprise a tag embedded with the media object or an item stored in a database and associated with the media asset. Further, the playlist may include at least one edit instruction for editing one of the media assets

In another example, a method for tracking a media asset used in a compilation of media assets includes generating a reference for a media asset, the reference associated with a source of the media asset, generating a playlist of multiple media assets, the playlist comprising the reference for the media asset, and causing display of the media assets per the playlist using the generated reference to access the media asset. In one example, a reference is generated for each media asset used in the compilation, and the playlist includes a reference for each of the media assets. The method may further include tracking the uses of the media asset in subsequent uses, and generating an additional reference for the media asset associated with the subsequent use.

According to another aspect of the present invention, apparatus for creating a compilation of media assets is provided. In one example, the apparatus includes logic for generating a playlist referencing a first media asset and a second media asset, wherein the first media asset has a reference associated therewith identifying a source of the first media asset, and logic for causing display of the first media asset and the second media asset per the playlist. The apparatus may further include logic for causing the generation of the reference associated with the source of the first media asset.

In another example, the apparatus may include logic for tracking subsequent use of the first media asset. In yet another example, the apparatus may further include logic for bidirectional linking of users based on the uses of the media asset; for example, linking multiple users, web site pages, advertisers, etc., based on the use of the media asset.

In another aspect, a computer-readable medium comprising instructions for creating a compilation of media assets is provided. In one example, the instructions may be for causing the method comprising generating a playlist (which may include one or more edit instructions) referencing a first media asset and a second media asset, wherein the first media asset has a reference associated therewith identifying a source of the first media asset, and causing display of the first media asset and the second media asset per the playlist. The second media asset may further have a second reference associated therewith identifying a source thereof.

In another example, the instructions are for tracking the use of media assets and may be for causing generating a reference for a media asset, the reference associated with a source of the media asset, generating a playlist of multiple media assets, the playlist comprising the reference for the media asset, and causing display of the media assets per the playlist using the generated reference to access the media asset. In one example, a reference is generated for each media asset used in the compilation, and the playlist includes a reference for each of the media assets. The method may further include tracking the uses of the media asset in subsequent uses, and generating an additional reference for the media asset associated with the subsequent use.

The various aspects and examples of the present inventions are better understood upon consideration of the detailed description below in conjunction with the accompanying drawings and claims.

### BRIEF DESCRIPTION OF THE DRAWINGS

The following drawing figures, which form a part of this application, are illustrative of embodiments, systems, and methods described below and are not meant to limit the scope of the invention in any manner, which scope shall be based on the claims appended hereto.

FIG. 1 illustrates an exemplary environment and data flow for certain aspects of the present invention.

FIG. 2 illustrates an exemplary method for rendering and displaying a compilation of media assets according to one example.

FIG. 3 illustrates an exemplary method for bi-directional tagging or referencing of media assets for determining source information and subsequent uses.

FIG. 4 illustrates an exemplary method for editing and uploading a media asset to create a compilation of media assets according to one example.

FIG. 5 illustrates an exemplary interface for viewing and editing media assets.

FIG. 6 illustrates an exemplary system for manipulating a media asset in a networked computing environment.

FIG. 7 illustrates another exemplary media for manipulating a media asset in a networked computing environment.

FIG. 8 illustrates an exemplary computing system that may be employed to implement processing functionality for various aspects of the invention.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

For the sake of convenience, at times, videos are used and described as examples of media assets manipulated and subject to edit instructions/specifications by the exemplary devices, interfaces, and methods; however, those skilled in the art will recognize that the various examples apply similarly or equally to other media assets, subject to appropriate modifications and use of other functions where appropriate (e.g., viewing and editing a media asset may apply to editing a video file (with or without audio), editing an audio file, such as a soundtrack, editing still images, effect, titles, and combinations thereof). Further, as used herein, an “asset” or “media asset” generally refers to a logical collection of content that may be comprised within one or more files. For example, an asset may be comprised of a single file (e.g., an MPEG video file) that contains images (e.g., a still frame of video), audio, and video information. As another example, an asset may be comprised of a file (e.g., a JPEG image file) or a collection of files (e.g., JPEG image files) that may be used with other media assets or collectively to render an animation or video. As yet another example, an asset may also comprise an executable file (e.g., an executable vector graphics file, such as an SWF file or an FLA file).

In existing media asset systems, e.g., video editing systems, there is typically a source of content for which multiple services have access. For example, multiple news services may have access to a particular video feed or clip and wish to provide separate stories on the news clip (e.g., inserting comments, other video or audio clips, and so on, thereby creating a compilation media asset). Additionally, multiple users may access various media assets available, e.g., via web-based media player and editor application and reuse or remix the media assets into compilations of many different media assets. Conventionally, it is generally difficult to edit the original media asset to include comments or other media assets, and is further generally difficult for a recipient of the remixed or compilation media asset to determine the source of the various media assets used therein.

In one example described here, tags are embedded into each media asset for identifying a source of the media asset as it is used in combinations and compilations with other media assets. In another example, a database, e.g., an external or remote canonical database, collects the meta data surrounding each media asset as it is added or moves through a system or network provider. The database may maintain information on the location and usage of the media asset as it is used in a compilation of media assets, thereby allowing for identification of source information and tracking subsequent uses.

In one example, as a user views and selects a media asset for use in a compilation of media assets or remix of media assets, a playlist of the media assets is generated based on tags embedded in the media assets (or a reference stored in a database). The tags (or references) are used as pointers to the source or location of the media asset. Accordingly, instead of the media asset needing to be copied and reused for the desired compilation or remix, an auto assembly technology may be used to display the media asset within the compilation or remix while maintaining its independence at the same time. For example, a user may use an on-the-fly media creation application, e.g., a media editor application such as Jumpcut, to visually portray the media assets as part of a compilation, whereby the media assets remain in their original state but are displayed as part of the desired compilation. Further, the system may trackback to the source of the original media asset, thus retaining the original rights information, as the media asset has remained an independent entity.

Tagging or referencing media assets may be used for assembly, trackback, discovery, and sourcing of media assets. Additionally, such features may allow for source material to be referenced in order to connect to original source of a media object, to facilitate attribution and revenue for a nested set of contributors, to determine proportionality of revenues within compilations of media assets, and the like. Accordingly, tagging or referencing each media asset used in a compilation of media assets may allow for an improved method and system for users to determine edit and distribution history as well as media asset owners/providers to track provided media assets.

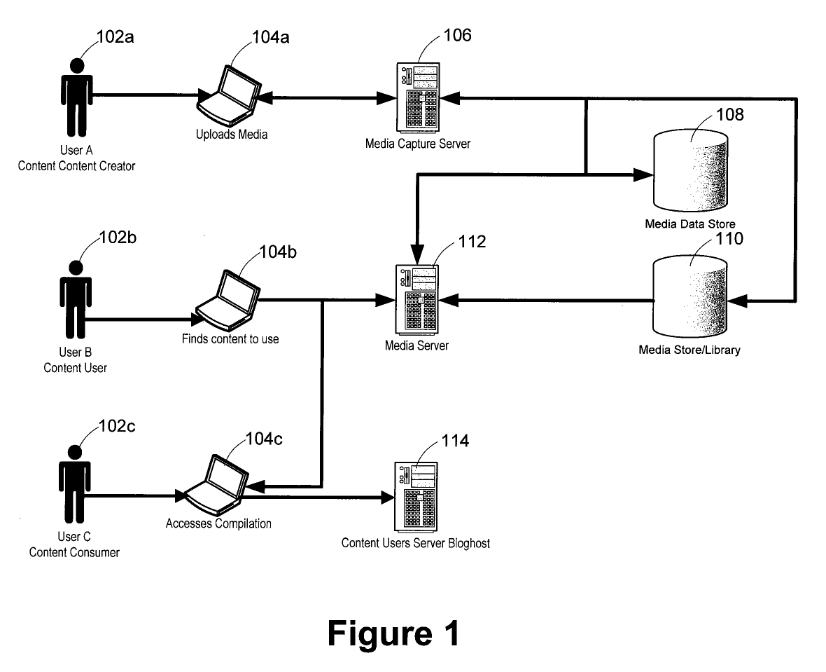

FIG. 1 illustrates an exemplary environment and data flow for some aspects of the present invention. User 102a, e.g., a content creator, creates a media asset and uploads the media asset to a media capture server 106 via a computing device 104, e.g., a client device. In one example, meta data describing the media object is saved in a data store 108, which may include a canonical data store, via media capture server 106. The meta data may include machine or user-generated data such as machine identifications, user identifications, title, subject, author, source, use rights, and the like. In one example, data store 108, collects and maintains the meta data surrounding each uploaded media asset, e.g., the tag or reference associated with the media asset, which may be used to identify the media asset as it is used subsequently in compilations of media assets.

In one example, an application such as a media editor or upload application running on device 104 may add tags or generate a reference for storage in the data store 108 associating the media asset with a source, e.g., with device 104 or user 102a. The tag or reference may be obtained at least partially from meta data associated with the media object. In other examples, the tags or references may be generated by media capture server 106. In yet other examples, the tags or references may be generated by another computing device such as media server 112 described below.

User 102b, which may be the same or different as user 102a, may view content in a media asset gallery via media server 112 and select one or more media assets for reuse in a compilation of media assets (e.g., including two or more media assets; sometimes referred to as an “aggregate media asset”). User 102b may create and host a compilation media asset on an associated server 114, e.g., a web server or blog host server.

User 102b may select various media assets to create a compilation of media assets, however, unlike a typical compilation the compilation of the present example is not a single media asset onto itself, but rather is a playlist (including one or more edit specifications, for example) that refers or points to media assets stored in the media store 110 and portions of those media assets. For example, the compilation may include a playlist having tags or references which may be used as a pointer to the original location of the media, e.g., in media store 110. An auto assembly application (for example, as described in previously filed U.S. patent application Ser. No. 11/784,843, the contents of which are incorporated by reference herein) may be used to render and display the media assets per the playlist without the need to copy and reuse the media assets. For example, a playlist for a compilation of media assets created by user 102b could contain the following data:

clip 1—start at 00:00—play from 00:00 to 01:35

clip 2—start at 01:00—play all

clip 3—start at 01:30—play from 10:04 to 10:32

clip 4—start at 00:00—play all—audio clip

As seen from this example, the playlist directs that clips 1 and 2 will play simultaneously for 35 seconds, and clip 4, an audio track, overlays all 3 video tracks. Accordingly, the compilation includes references to various media assets at their source, in this example, with media store 110.

User 102c, e.g., a content consumer, may access the compilation media asset via client device 104c. For example, a media player application running on client device 104c operates to play media assets via media server 112 and media store 110 as directed by the compilation playlist, where client device 104c and/or media server 112 operate to access and render each media asset on the playlist.

Another illustrative example includes temporally tagging or referencing a first media asset with a second media asset to generate a compilation. For instance, a first media asset may include a video for which a user, e.g., a commentator, wishes to embed video comments therein (e.g., to display video comments sequentially after a portion of the video). In a traditional model, editing tools would need to be used in order to chop the original video into segments, add the commentator's comments, etc. to form a new media asset. In an example provided here, the video may be tagged at the points the commentator wishes to comment on. The commentator may then record and store comments on each segment, e.g., in a media store 110. User 102c, e.g., a content consumer, may view the compilation via a viewer, which detects (e.g., via a received playlist) which of the two media assets to play when and for how long. For example, the first media asset may play for 2 minutes, then the commentator's first comment will play, then the first media asset will play again, and so on. Rather than having to edit the two media assets together for delivery and display to user 102c, segments of each media asset may be played in sequence based on a playlist created by an editor application.

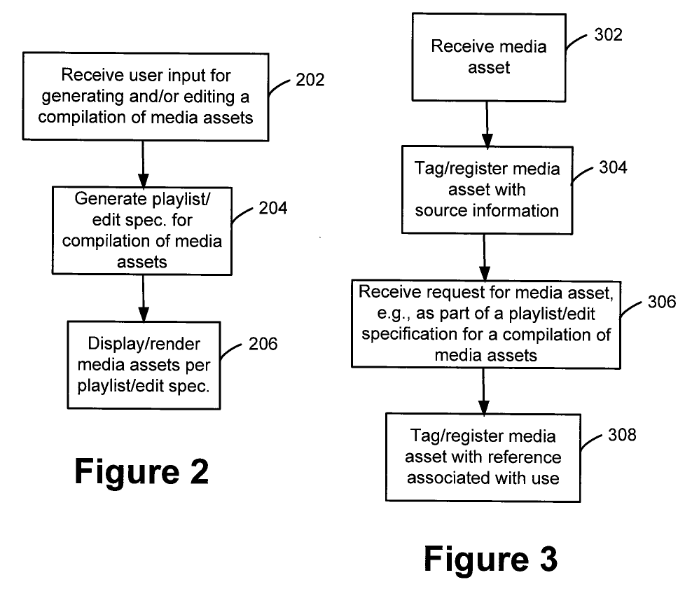

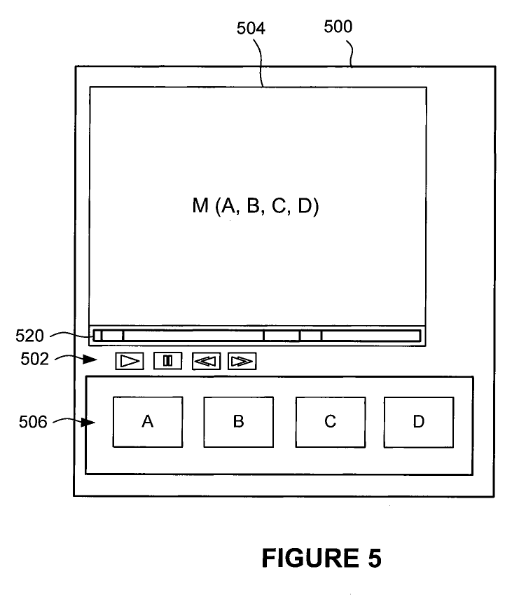

FIG. 2 illustrates an exemplary method for rendering and displaying a compilation of media assets according to one example. The method initially includes receiving user input for generating and/or editing a compilation media asset. User input may include edits to one or more media assets; for example, a user may view and edit remotely stored media assets into a compilation of media assets via an interface as illustrated in FIG. 5 (described in greater detail below). Additionally, user input may include user-generated media assets such as user generated audio/video files, images, comments, and so one, which may be uploaded to a remote store. For example, a user may view a media asset and upload a media asset, e.g., a video commentary, for use in a compilation of the original media asset and the uploaded media asset.

In response to the user input, the method includes generating a playlist (which may include one or more edit specifications) associated with a plurality of media assets at 204, the playlist for rendering or displaying a compilation of the media assets. As previously described, media assets are tagged and/or registered in a database; for example, as users or a service provider add media assets to a media asset library or makes the media assets otherwise available they are tagged and/or registered with information to allow identifying source information and tracking their use in future media assets. Accordingly, in one example, the playlist includes the tags and/or references to the source of the media asset, e.g., a media asset library. Additionally, the playlist may include edit specifications indicating, e.g., portion(s) of the media asset to display and so on.

The method further includes causing a rendering and/or displaying of the media assets per the playlist in 206. For instance, in one example, the media server may access and display each media asset per the playlist to display the desired compilation of media assets. In one example, the individual media assets displayed in the compilation per the playlist retain their original form and metadata. Maintaining the original form and metadata, although displayed in a compilation, allows for a user and or service provider to track back to the source of the original media asset and retain original rights information, for example. Further, as a media asset is used in a compilation, this information may be tracked and stored as a tag or stored reference to provide bi-directional referencing of the media asset, e.g., tracking current and future uses of the media asset and linking users of the media assets.

FIG. 3 illustrates an exemplary method for bi-directional tagging or referencing of media assets used in compilation media assets. In one example, the method initially includes receiving a media asset at 302. The media asset may be received from a user device, a remote service provider network, remote storage library, or the like. The method further including tagging or storing references associated with media assets received at 304. For example, in response to a user uploading a media asset a tag or reference may be stored, the tag or reference indicating a source and/or rights information associated with the media asset.

The method further including receiving a request for a media asset at 306. For example, the request may be part of a received playlist and/or edit specification associated with one or more media assets previously received and/or tagged/registered in 302 or 304. The method further including tagging the media asset or registering the use of the media asset. For example, storing or registering the requester of the media asset to provide tracking of the use of the media asset by other users in compilations, and linking users that use the same media asset.

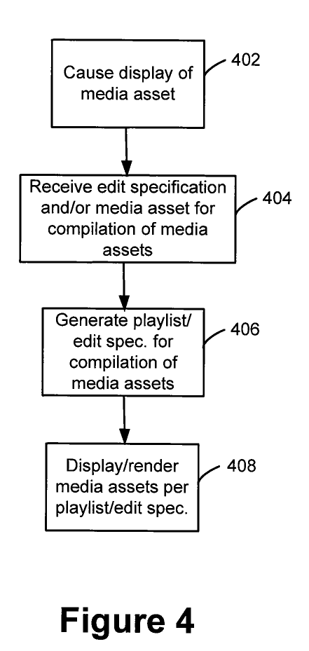

FIG. 4 illustrates an exemplary method for editing and uploading a media asset to create a compilation of media assets according to one example. The method may initially display a media asset at 402. For example, a media server device may communicate a media asset from a media store to a remote device for display within a browser window or web-based media player/editor application. In other examples, a media server may communicate a link to the source of a particular media asset for display.

The method further including receiving an edit specification and/or media asset for creating a compilation media asset in 404, the compilation including the media asset displayed in 402. For example, a user viewing a first displayed media asset in 402 may upload media assets or associate and edit a second media asset with the first media asset to create a compilation. In response to the received edit specifications and/or media assets the method may further include generating a playlist (which may include the received edit specification) for the compilation at 406. The method may further include causing a display or rendering of the media assets per the playlist and edit specifications at 408, thereby displaying or rendering the desired compilation.

The various methods described and shown may be carried out by any combination of software, hardware, or firmware. In one example, the exemplary methods comprise computer-implemented methods, which may be carried out by software operating on one or more computing devices, e.g., a server device, client device, and the like. Further, various methods may be carried out in orders other than those shown in the blocks, and in some instances one or more blocks may be carried out at least partially in parallel.

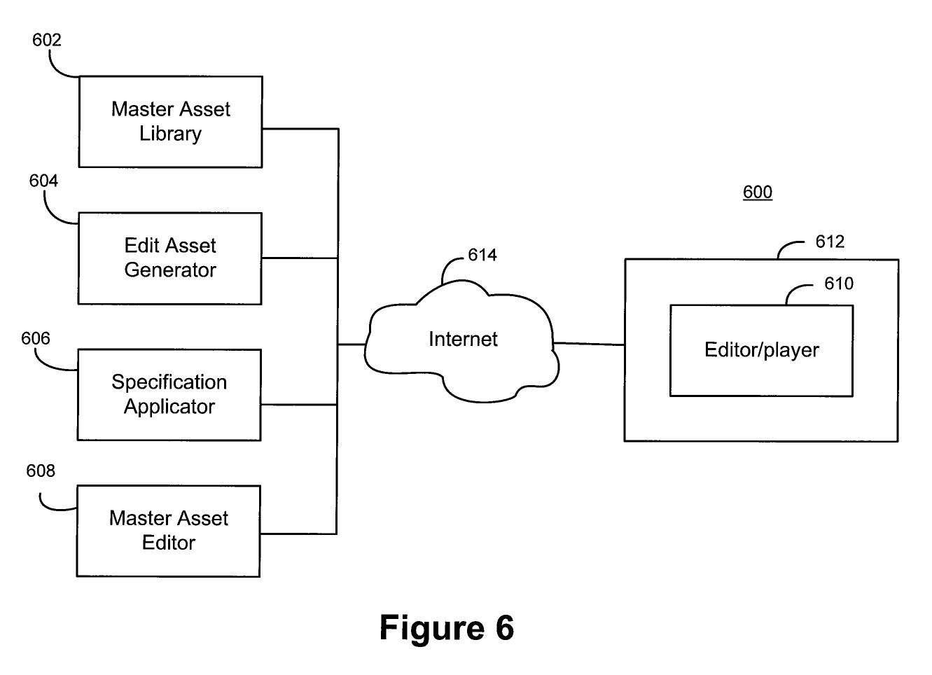

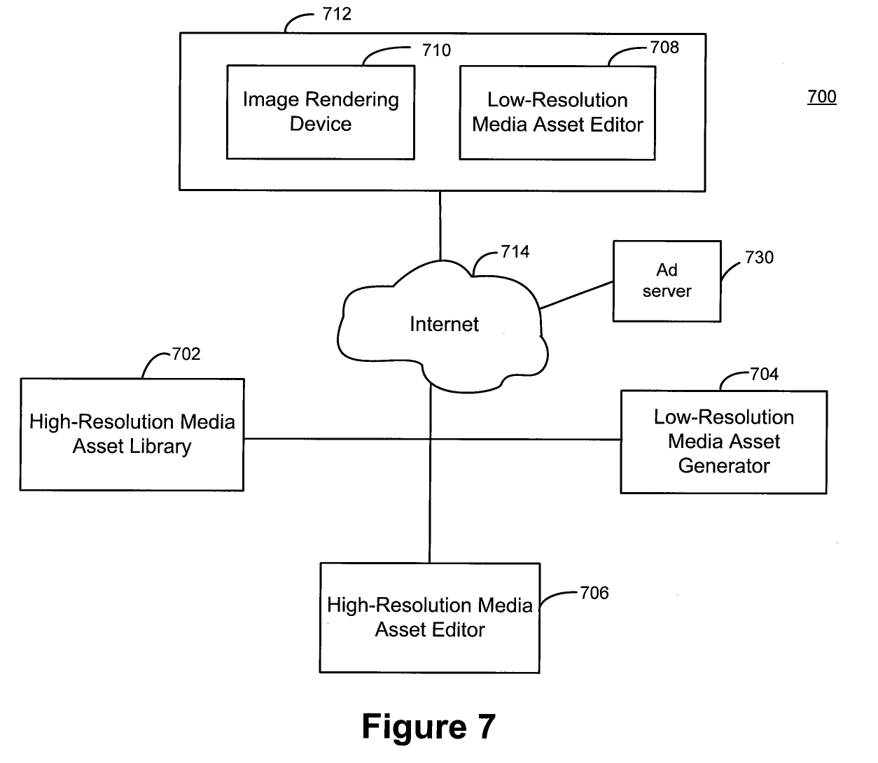

FIG. 5 illustrates an exemplary interface 500 for viewing and editing media assets, including compilation media assets. Interface 500 may include a media player having editing and assembly functions as described in FIGS. 6 and 7 below and similarly described, for example, in co-pending U.S. patent application Ser. Nos. 11/784,843, 11/784,918, 11/786,016, and 11/786,020, all of which were filed on Apr. 9, 2007, and all of which are hereby incorporated by reference. In other examples, however, interface 500 may include only play functionality for displaying media assets, e.g., according to a received playlist. Further, interface 500 may be a stand alone window displayed on a remote device, e.g., a client device, or embedded within a browser window of a client device.

In this illustrative example, interface 500 includes a display portion 504 for displaying media assets, a tile portion 506 for displaying media assets, and a control portion 502 which may include various controls (such as play, stop, pause, etc.). Additionally, interface 500 may include a timeline 520 associated with the displayed media asset, and in one example, divided according to individual media assets of a compilation media asset.

In one example, interface 500 operates to display a compilation media asset, e.g., shown as M(A, B, C, D), composed of individual media assets A, B, C, and D. Each of the individual media assets A, B, C, and D are illustrated below as tiles within tile portion 506 (each tile may be associated with different media assets used in a compilation or aggregate media asset or for editing a media asset as described more fully in the aforementioned applications incorporated by reference herein). A user may access individual media assets via the tiles, e.g., by selecting a tile, to view the media asset, associated information, to download, or the like. For example, media asset A may be displayed in display portion 504 in response to a selection thereof. Additionally, metadata associated with media asset A may be displayed in response to a selection thereof. Further, the user may download and/or edit the media asset to generate a new media asset (which may include editing the compilation media asset or using the particular media asset in a new media asset).

Further, in some examples where a small portion of a media asset is used in the compilation media asset, e.g., a few second clip from an hour long video, the entire media asset may be accessed in response to a selection of the associated tile. Various other controls and features for a media editor may be included and are contemplated.

Interface 500 may further include various other features such a search interface for searching for media assets in an on-line client-server architecture as described, as well as with other local or remote stores. It will be understood that user interface 500 is one specific example of a user interface for viewing and/or editing media assets, which may be embedded within a browser window, and various other media players having different functionalities and appearances may be used. For example, a media player could include functions not described here as well as fewer functions than described here.

One skilled in the art will recognize that many different systems and methods can facilitate the generation of a media asset and communication to a device as described. One exemplary system and method is described in FIGS. 6 and 7 below. For instance, the following describes a system and method for viewing and editing media assets, causing the generation of edit specifications, allowing a user to view and/or edit a low-resolution version of a remotely stored high-resolution media asset (e.g., stored in a media asset library), and so on. This is illustrative of some particular examples, and it will be understood that other systems and methods for editing and communicating media assets to remote users are possible and contemplated; for example, various known media players and/or web based editor applications may be similarly used to implement the invention described. It will be understood, however, that other media player/editor applications, e.g., that do not use/generate low-resolution media assets, edit specifications, and the like, are contemplated for use as described.

FIG. 6 illustrates an exemplary system 600 for generating a media asset or compilation of media assets as described. In one example, system 600 is comprised of a master asset library 602 (e.g., similar to media store 110 described above). In one example, a master asset library 602 may be a logical grouping of data, including but not limited to high-resolution and low-resolution media assets. In another embodiment, a master asset library 602 may be a physical grouping of data, including but not limited to high-resolution and low-resolution media assets. In an embodiment, a master asset library 602 may be comprised of one or more databases and reside on one or more servers. In one embodiment, master asset library 602 may be comprised of a plurality of libraries, including public, private, and shared libraries. In one embodiment, a master asset library 602 may be organized into a searchable library. In another embodiment, the one or more servers comprising master asset library 602 may include connections to one or more storage devices for storing digital files.

Master asset library 602 may include many types of assets, including but not limited to, video, images, animations, text, executable files, and audio. In one embodiment, master asset library 602 may include one or more high-resolution master assets. For the remainder of this disclosure, “master asset” will be disclosed as a digital file containing video content. One skilled in the art will recognize, however, that a master asset is not limited to containing video information, and as set forth previously, a master asset may contain many types of information including but not limited to images, audio, text, executable files, and/or animations.

In one embodiment, a media asset may be stored in a master asset library 602 so as to preserve the quality of the media asset. For example, in the case of a media asset comprising video information, two important aspects of video quality are spatial resolution and temporal resolution. Spatial resolution generally describes the clarity of lack of blurring in a displayed image, while temporal resolution generally describes the smoothness of motion. Motion video, like film, consists of a certain number of frames per second to represent motion in the scene. Typically, the first step in digitizing video is to partition each frame into a large number of picture elements, or pixels or pels for short. The larger the number of pixels, the higher the spatial resolution. Similarly, the more frames per second, the higher the temporal resolution.

In one embodiment, a media asset may be stored in a master asset library 602 as a master asset that is not directly manipulated. For example, a media asset may be preserved in a master asset library 602 in its original form, although it may still be used to create copies or derivative media assets (e.g., low-resolution assets). In one embodiment, a media asset may also be stored in a master asset library 602 with corresponding or associated assets. In one embodiment, a media asset stored in a master asset library 602 may be stored as multiple versions of the same media asset. For example, multiple versions of a media asset stored in master asset library 602 may include an all-keyframe version that does not take advantage of intra-frame similarities for compression purposes, and an optimized version that does take advantage of intra-frame similarities. In one embodiment, the original media asset may represent an all-keyframe version. In another embodiment, the original media asset may originally be in the form of an optimized version or stored as an optimized version. One skilled in the art will recognize that media assets may take many forms within a master asset library 602 that are within the scope of this disclosure.

In one embodiment, a system 600 is also comprised of an edit asset generator 604. In an embodiment, an edit asset generator 604 may be comprised of transcoding hardware and/or software that, among other things, may convert a media asset from one format into another format. For example, a transcoder may be used to convert an MPEG file into a Quicktime file. As another example, a transcoder may be used to convert a JPEG file into a bitmap (e.g., *.BMP) file. As yet another example, a transcoder may standardize media asset formats into a Flash video file (*.FLV) format. In one embodiment, a transcoder may create more than one versions of an original media asset. For example, upon receiving an original media asset, a transcoder may convert the original media asset into a high-resolution version and a low-resolution version. As another example, a transcoder may convert an original media asset into one or more files. In one embodiment, a transcoder may exist on a remote computing device. In another embodiment, a transcoder may exist on one or more connected computers. In one embodiment, an edit asset generator 604 may also be comprised of hardware and/or software for transferring and/or uploading media assets to one or more computers. In another embodiment, an edit asset generator 604 may be comprised of or connected to hardware and/or software used to capture media assets from external sources such as a digital camera.

In one embodiment, an edit asset generator 604 may generate a low-resolution version of a high-resolution media asset stored in a master asset library 602. In another embodiment, an edit asset generator 604 may transmit a low-resolution version of a media asset stored in a master asset library 602, for example, by converting the media asset in real-time and transmitting the media asset as a stream to a remote computing device. In another embodiment, an edit asset generator 604 may generate a low quality version of another media asset (e.g., a master asset), such that the low quality version preserves while still providing sufficient data to enable a user to view and apply edits to the low quality version.

In one embodiment, a system 600 may also be comprised of a specification applicator 606. In one embodiment, a specification applicator 606 may be comprised of one or more files or edit specifications that include edit instructions for editing and modifying a media asset (e.g., a high-resolution media asset). In one embodiment, a specification applicator 606 may include one or more edit specifications that comprise modification instructions for a high-resolution media asset based upon edits made to a corresponding or associated low-resolution media asset. In one embodiment, a specification applicator 606 may store a plurality of edit specifications in one or more libraries.

In one embodiment, a system 600 is also comprised of a master asset editor 608 that may apply one or more edit specifications to a media asset. For example, a master asset editor 608 may apply an edit specification stored in a specification applicator 606 library to a first high-resolution media asset and thereby creates another high-resolution media asset, e.g., a second high-resolution media asset. In one embodiment, a master asset editor 608 may apply an edit specification to a media asset in real-time. For example, a master asset editor 608 may modify a media asset as the media asset is transmitted to another location. In another embodiment, a master asset editor 608 may apply an edit specification to a media asset in non-real-time. For example, a master asset editor 608 may apply edit specifications to a media asset as part of a scheduled process. In one embodiment, a master asset editor 608 may be used to minimize the necessity of transferring large media assets over a network. For example, by storing edits in an edit specification, a master asset editor 608 may transfer small data files across a network to effectuate manipulations made on a remote computing device to higher quality assets stored on one or more local computers (e.g., computers comprising a master asset library).

In another embodiment, a master asset editor 608 may be responsive to commands from a remote computing device (e.g., clicking a “remix” button at a remote computing device may command the master asset editor 608 to apply an edit specification to a high-resolution media asset). For example, a master asset editor 608 may dynamically and/or interactively apply an edit specification to a media asset upon a user command issuing from a remote computing device. In one embodiment, a master asset editor 608 may dynamically apply an edit specification to a high-resolution to generate an edited high-resolution media asset for playback. In another embodiment, a master asset editor 608 may apply an edit specification to a media asset on a remote computing device and one or more computers connected by a network (e.g., Internet 614). For example, bifurcating the application of an edit specification may minimize the size of the edited high-resolution asset prior to transferring it to a remote computing device for playback. In another embodiment, a master asset editor 608 may apply an edit specification on a remote computing device, for example, to take advantage of vector-based processing that may be executed efficiently on a remote computing device at playtime.

In one embodiment, a system 600 is also comprised of an editor/player 610 that may reside on a remote computing device 612 that is connected to one or more networked computers, such as the Internet 614. In one embodiment, an editor/player 610 may be comprised of software. For example, editor/player 610 may be a stand-alone program. As another example, editor/player 610 may be comprised of one or more instructions that may be executed through another program such as an Internet 614 browser (e.g., Microsoft Internet Explorer). In one embodiment, editor/player 610 may be designed with a user interface similar to other media-editing programs. In one embodiment, editor/player 610 may contain connections to a master asset library 602, an edit asset library 604, a specification applicator 606 and/or a master asset editor 608. In one embodiment, editor/player 610 may include pre-constructed or “default” edit specifications that may be applied by a remote computing device to a media asset. In one embodiment, editor/player 610 may include a player program for displaying media assets and/or applying one or more instructions from an edit specification upon playback of a media asset. In another embodiment, editor/player 610 may be connected to a player program (e.g., a standalone editor may be connected to a browser).

FIG. 7 illustrates an embodiment of a system 700 for generating a media asset or a compilation of media assets, for example, in response to receiving user input such as edits to one or more media assets, uploaded media assets, and so on. In one embodiment, the system 700 comprises a high-resolution media asset library 702. In one embodiment, the high-resolution media asset library 702 may be a shared library, a public library, and/or a private library. In one embodiment, the high-resolution media asset library 702 may include at least one video file. In another embodiment, the high resolution media asset library 702 may include at least one audio file. In yet another embodiment, the high-resolution media asset library 702 may include at least one reference to a media asset residing on a remote computing device 712. In one embodiment, the high-resolution media asset library 702 may reside on a plurality of computing devices.

In one embodiment, the system 700 further comprises a low-resolution media asset generator 704 that generates low-resolution media assets from high-resolution media assets contained in the high-resolution media asset library. For example, as discussed above, a low-resolution media asset generator 704 may convert a high-resolution media asset to a low-resolution media asset.

In one embodiment, the system 700 further comprises a low-resolution media asset editor 708 that transmits edits made to an associated low-resolution media asset to one or more computers via a network, such as the Internet 714. In another embodiment, the low-resolution media asset editor 708 may reside on a computing device remote from the high resolution media asset editor, for example, remote computing device 712. In another embodiment, the low-resolution media asset editor 708 may utilize a browser. For example, the low-resolution media asset editor 708 may store low-resolution media assets in the cache of a browser.

In one embodiment, the system 700 may also comprise an image rendering device 710 that displays the associated low-resolution media asset. In one embodiment, an image rendering device 710 resides on a computing device 712 remote from the high-resolution media asset editor 706. In another embodiment, an image rendering device 710 may utilize a browser. In one embodiment, the system 700 further comprises a high-resolution media asset editor 706 that applies edits to a high-resolution media asset based on edits made to an associated low-resolution media asset.

Computing device 712 includes suitable hardware, firmware, and/or software for carrying out the described functions, such as a processor connected to an input device (e.g., a keyboard), a network interface, a memory, and a display. The memory may include logic or software operable with the device to perform some of the functions described herein. The device may be operable to include a suitable interface for editing media assets as described herein. The device may further be operable to display a web browser for displaying an interface for editing media assets as described.

Additionally, an advertisement server 730 may operate to cause the delivery of an advertisement to computing device 712. Advertisement server 730 may also associate advertisements with media assets, playlists, edit specifications, etc. transmitted to or from remote computing device 712. For example, advertisement server 730 may include logic for causing advertisements to be displayed with or associated with delivered media assets or edit specifications based on various factors such as the media assets generated, accessed, viewed, uploaded, and/or edited, as well as other user activity data associated therewith. In other examples, the advertisements may alternatively or additionally be based on activity data, context, user profile information, or the like associated with computing device 712 or a user thereof (e.g., accessed via remote computing device 712 or an associated web server). In yet other examples, the advertisements may be randomly generated or associated with computer device 712 or media assets and delivered to remote computing device 712.

It will be recognized that high-resolution media asset library 702, low-resolution media asset generator 704, high resolution media asset editor 706, and advertisement server 730 are illustrated as separate items for illustrative purposes only. In some examples, the various features may be included in whole or in part with a common server device, server system or provider network (e.g., a common backend), or the like; conversely, individually shown devices may be comprise multiple devices and be distributed over multiple locations. Further, various additional servers and devices may be included such as web servers, media servers, mail servers, mobile servers, and the like as will be understood by those of ordinary skill in the art.

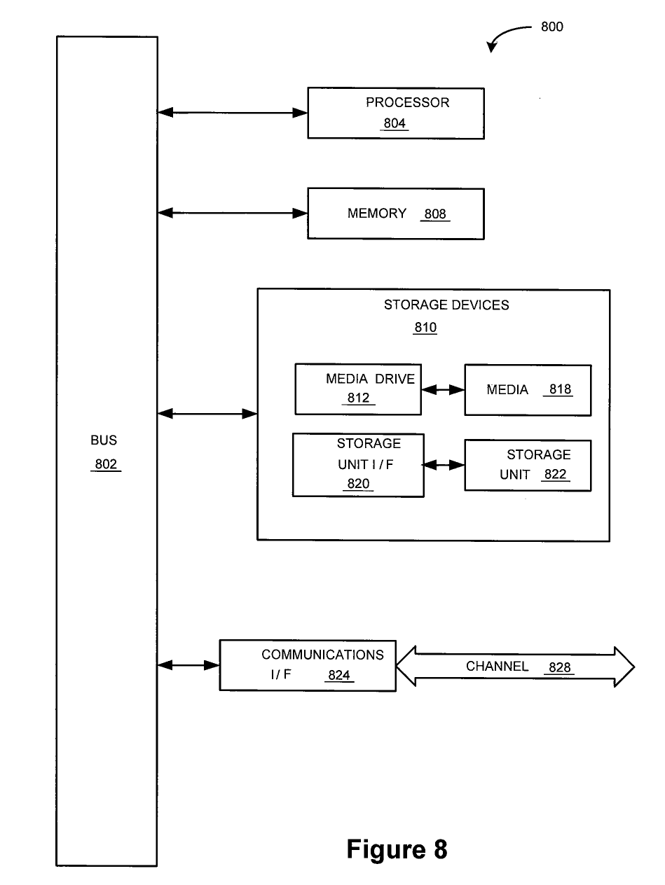

FIG. 8 illustrates an exemplary computing system 800 that may be employed to implement processing functionality for various aspects of the invention (e.g., as a user/client device, media server, media capture server, media data store, media asset library, activity data logic/database, advertisement server, combinations thereof, and the like.). Those skilled in the relevant art will also recognize how to implement the invention using other computer systems or architectures. Computing system 800 may represent, for example, a user device such as a desktop, mobile phone, personal entertainment device, DVR, and so on, a mainframe, server, or any other type of special or general purpose computing device as may be desirable or appropriate for a given application or environment. Computing system 800 can include one or more processors, such as a processor 804. Processor 804 can be implemented using a general or special purpose processing engine such as, for example, a microprocessor, microcontroller or other control logic. In this example, processor 804 is connected to a bus 802 or other communication medium.

Computing system 800 can also include a main memory 808, preferably random access memory (RAM) or other dynamic memory, for storing information and instructions to be executed by processor 804. Main memory 808 also may be used for storing temporary variables or other intermediate information during execution of instructions to be executed by processor 804. Computing system 800 may likewise include a read only memory (“ROM”) or other static storage device coupled to bus8O2 for storing static information and instructions for processor 804.

The computing system 800 may also include information storage mechanism 810, which may include, for example, a media drive 812 and a removable storage interface 820. The media drive 812 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 818 may include, for example, a hard disk, floppy disk, magnetic tape, optical disk, CD or DVD, or other fixed or removable medium that is read by and written to by media drive 814. As these examples illustrate, the storage media 818 may include a computer-readable storage medium having stored therein particular computer software or data.

In alternative embodiments, information storage mechanism 810 may include other similar instrumentalities for allowing computer programs or other instructions or data to be loaded into computing system 800. Such instrumentalities may include, for example, a removable storage unit 822 and an interface 820, such as a program cartridge and cartridge interface, a removable memory (for example, a flash memory or other removable memory module) and memory slot, and other removable storage units 822 and interfaces 820 that allow software and data to be transferred from the removable storage unit 818 to computing system 800.

Computing system 800 can also include a communications interface 824. Communications interface 824 can be used to allow software and data to be transferred between computing system 800 and external devices. Examples of communications interface 824 can include a modem, a network interface (such as an Ethernet or other NIC card), a communications port (such as for example, a USB port), a PCMCIA slot and card, etc. Software and data transferred via communications interface 824 are in the form of signals which can be electronic, electromagnetic, optical, or other signals capable of being received by communications interface 824. These signals are provided to communications interface 824 via a channel 828. This channel 828 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 808, storage device 818, storage unit 822, or signal(s) on channel 828. These and other forms of computer-readable media may be involved in providing one or more sequences of one or more instructions to processor 804 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into computing system 800 using, for example, removable storage drive 814, drive 812 or communications interface 824. The control logic (in this example, software instructions or computer program code), when executed by the processor 804, causes the processor 804 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. A method for creating a compilation of media assets, the method comprising:
generating a playlist referencing a first media asset and a second media asset, wherein the first media asset has a reference associated therewith identifying a source of the first media asset; and
causing display of the first media asset and the second media asset per the playlist.

2. The method of claim 1, wherein the second media asset has a second reference associated therewith identifying a source thereof.

3. The method of claim 1, wherein the reference identifies both the source of the first media asset and use of the first media asset.

4. The method of claim 1, wherein the first media asset further has a second reference associated therewith identifying a user of the media asset.

5. The method of claim 1, wherein the reference comprises a tag embedded with the first media asset.

6. The method of claim 1, wherein the reference comprises an item stored in a database and associated with the first media asset.

7. The method of claim 1, wherein the playlist comprises at least one edit instruction.

8. A method for tracking a media asset used in a compilation of media assets, comprising:
generating a reference for a media asset, the reference associated with a source of the media asset;
generating a playlist of multiple media assets, the playlist comprising the reference for the media asset; and
causing display of the media asset per the playlist using the reference to access the media asset.

9. The method of claim 8, further comprising tracking use of the media asset.

10. The method of claim 8, further comprising generating a second reference for the media asset, the second reference associated with a subsequent use.

11. The method of claim 8, wherein the reference comprises a tag embedded with the media asset.

12. The method of claim 8, wherein the reference comprises an item stored in a database and associated with the media asset.

13. The method of claim 8, wherein the playlist comprises at least one edit instruction.

14. Apparatus for creating a compilation of media assets, the apparatus comprising:
logic for generating a playlist referencing a first media asset and a second media asset, wherein the first media asset has a reference associated therewith identifying a source of the first media asset; and
logic for causing display of the first media asset and the second media asset per the playlist.

15. The apparatus of claim 14, further comprising logic for causing the generation of the reference associated with the source of the first media asset.

16. The apparatus of claim 14, further comprising logic for tracking a use of the first media asset.

17. The apparatus of claim 16, further comprising logic for bidirectional linking of users based on use of the media asset

18. The apparatus of claim 14, wherein the reference comprises a tag embedded with the first media asset.

19. The apparatus of claim 14, wherein the reference comprises an item stored in a database and associated with the first media asset.

20. The apparatus of claim 14, wherein the playlist comprises at least one edit instruction.

21. A computer-readable medium comprising instructions for creating a compilation of media assets, the instructions for causing the method comprising:
generating a playlist referencing a first media asset and a second media asset, wherein the first media asset has a reference associated therewith identifying a source of the first media asset; and
causing display of the first media asset and the second media asset per the playlist.

22. The computer-readable medium of claim 21, wherein the second media asset has a second reference associated therewith identifying a source thereof.

23. The computer-readable medium of claim 21, wherein the reference identifies both the source of the first media asset and subsequent uses of the first media asset.

24. The computer-readable medium of claim 21, wherein the reference comprises a tag embedded with the first media asset.

25. The computer-readable medium of claim 21, wherein the reference comprises an item stored in a database and associated with the first media asset.

26. The computer-readable medium of claim 21, wherein the playlist comprises at least one edit instruction.
